(19) United States
(12) Patent Application Publication
(10) Pub. No.: US 2006/0069631 A1
(43) Pub. Date: Mar. 30, 2006

(54) System and method for providing an incentive program

(76) Inventors: Barry W. Goulding, Bethesda, MD (US); Katherine Morrison, Vienna, VA (US); Esther Wisdom, Falls Church, VA (US); Mark Merithew, Sterling, VA (US)

Correspondence Address: DICKSTEIN SHAPIRO MORIN & OSHINSKY LLP, 2101 L Street, NW, Washington, DC, 20037, US

(21) Appl. No.: 11/230,552

(22) Filed: Sep. 21, 2005

Related U.S. Application Data
(60) Provisional application No. 60/612,510, filed on Sep. 24, 2004.

(51) Int. Cl. G06Q 40/00

(52) U.S. Cl. 705/35

(57) ABSTRACT

The present invention provides a computer-based system and method for providing a management tool and incentive program that gives an incentive to borrowers to meet specified requirements. The program rewards the borrower with a benefit when the borrower satisfies the necessary requirements.

### FIELD OF THE INVENTION

The present invention relates to financial aid online application processes and account management services and specifically to a method and system for providing an incentive program for borrowers that reward those borrowers for participation.

### BACKGROUND OF THE INVENTION

Almost all students attending college and/or graduate school acquire some sort of education-related financing. For this reason, there is a huge market for financial aid financing during the educational experience and for loan consolidation options following graduation. As a result, lending institutions would like to keep their customers and gain their loyalty for a number of reasons such as the interest payments they accrue. Additionally, it is important to the lender that its borrowers make payments on-time.

With the advent of the Internet, it is now possible for lenders to provide online applications and loan management tools to their customers. While this is to the advantage of the customer, it is also to the advantage of the lender because the use of these electronic methods of applications and management tools are time and cost effective.

Incentive programs have become a good way for lending institutions to instill customer loyalty and encourage borrowers to adopt desired habits such as making loan payments on time and/or using online account management tools. Incentives can come in various forms, for example, they can comprise a reduced interest rate, reimbursed origination fees, balance credits, cash, etc. However, managing an incentive program can become cumbersome and complicated. For example, incentive programs often require lenders to determine eligibility, establish and monitor compliance with terms and conditions for the incentive, provide the incentive to the borrower and more. Additionally, management of the incentive program is increasingly complicated as the number of participants in the program grow. The burden of managing the incentive program itself can far outweigh the benefits gained by the lender. For this reason, there is a need for a computer program and methodology that can provide and manage an in-depth incentive program efficiently and effectively.

### BRIEF SUMMARY OF THE INVENTION

The invention is a management system and incentive program and process, implemented on a computer, that rewards borrowers who participate in a lender's online application process with a benefit, such as a loan balance reduction or cash award. When the borrower is determined to be eligible for the benefit, the benefit is automatically awarded to the borrower. If the borrower fails to continue to satisfy the terms and conditions for receiving the benefit, the benefit can be retracted.

### BRIEF DESCRIPTION OF THE DRAWINGS

The foregoing and other advantages of the invention will become more apparent from the detailed description of exemplary embodiments provided below with reference to the accompanying drawings in which:

FIG. 1 is a block diagram overview of the system and environment, according to an exemplary embodiment of the invention;

FIG. 2 is a block diagram of the method containing the steps related to the online loan application process, according to an exemplary embodiment of the invention;

FIG. 3 is a block diagram of the method containing the steps related to the benefit distribution, according to the exemplary embodiment of the invention; and

FIG. 4 is a block diagram illustrating the eligibility determination function of the method, according to the exemplary embodiment of the invention.

### DETAILED DESCRIPTION OF THE INVENTION

The present invention provides a computer-based system and method for providing a management tool and incentive program that gives an incentive to borrowers to apply for loan products using an online application process. Further incentives provided by the invention include encouraging use of an online account management system to manage any loans, making payments on time, and maintaining a higher level of involvement with the lender. The program rewards the borrower with credit to the borrower's account or with cash when the borrower satisfies the necessary requirements for the incentive and maintains that status for a predefined time period.

The term “lender” refers to a financial institution that provides funds to a borrower. The term “borrower” refers to the person who receives the loan or benefit or some other entity or individual in need of a loan. The term “student” is used to refer to a particular type of borrower. The borrower, however, need not be a student. For example, the present invention can be implemented with any type of borrower program where an incentive is desired. The term “school” refers to educational institutions, but could instead be any other type of institution that serves as a vehicle and/or sponsor of programs provided by a lender. Typically, a school does not provide funds or issue loans.

An exemplary embodiment of the invention is described as follows.

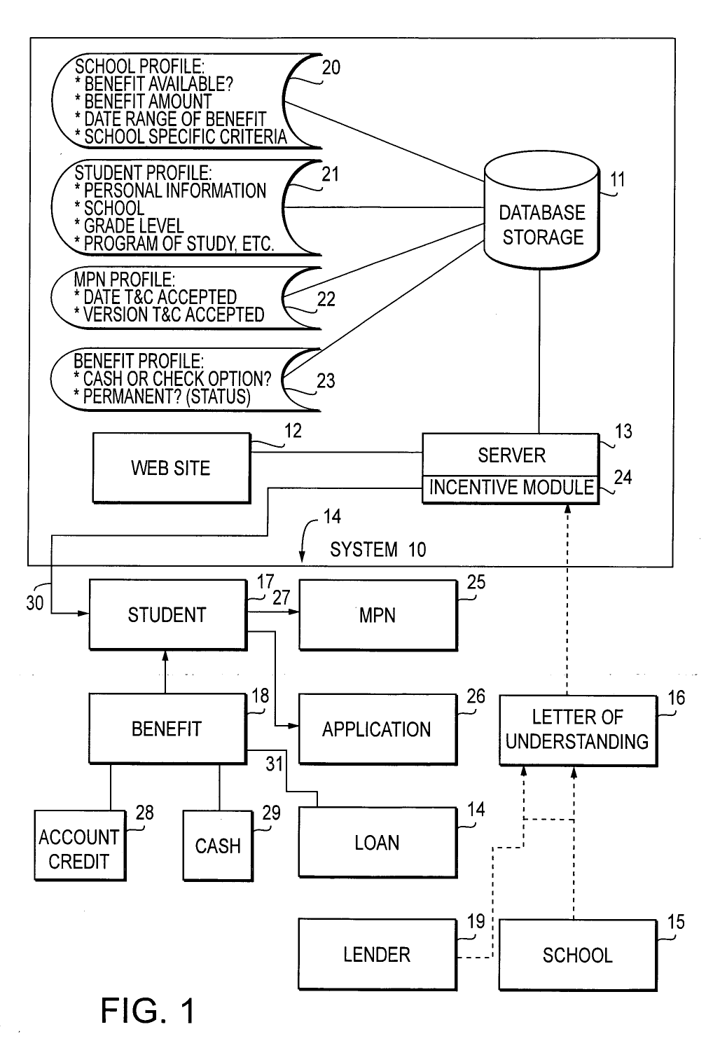

Referring now to FIG. 1, the figure shows an overview of a possible system 10. The system 10 can be implemented as the framework for an educational financial aid system or any other type of loan oriented environment. The system 10 comprises a server 13, website 12 and a database storage device 11. The server 13 hosts an incentive module 24 for managing the processes for determining eligibility of an incentive-derived benefit 18, providing a user interface via the website 12, and disbursing or retracting the benefit 18. The incentive module 24 can be a computer program application running on the server 13.

The database storage device 11 can take the form of any non-volatile storage hardware including but not limited to optical, magnetic, semi-conductor or tap storage or virtual storage in a WAN setting. The database storage device 11 stores information regarding the borrower, the school (or other institution), the incentive (i.e., the benefit) and the loan. In the illustrated embodiment, the database storage device 11 stores the school profile 20, student profile 21, Master Promissory Note (“MPN”) profile 22, and the benefit profile 23.

A school 15 and a lender 19 enter into an agreement that sets forth the benefits 18 that will be offered to the students 17 attending that particular school 15 and the terms and conditions of eligibility for the benefit 18. In this embodiment, a school 15 and a lender 19 enter an agreement by signing a letter of understanding (or agent) 16 (“LOU”). The agreement, however, need not be in writing. Electronic signature and processing of the LOU 16 can be accomplished through conventional electronic document processing hardware/software.

After the execution of the agreement, the letter of understanding 16 is then scanned and stored electronically in the server 13 or simply stored along with its signature (or designation indicating acceptance) and its terms, conditions and benefit 18 are set as criteria within the database storage device 11. Where the agreement is not written, only the terms, conditions and benefit 18 are set as criteria within the database storage device 11. The LOU 16 (or other agreement) may be modified, updated, supplemented or replaced. Accordingly, a plurality of agreements may be stored in the server 13 and their terms, conditions and benefit 18 can be set as criteria within the database storage device 11.

The terms and benefits on the database storage device 11 will be described as the school profile 20. The school profile 20 can also include any other eligibility criteria set by the lender 19 and/or the school 15. Relevant data in the school profile 20 includes information such as whether or not the benefit 18 is available to students 17 at the school 15 and the benefit 18 amount, as a percentage of the loan 14. School specific eligibility criteria for the benefit 18 are also stored in a separate linked field, including but not limited to, the date range over which the benefit 18 is available and any requirements as to owner of loan 14, grade level, program of study, or academic year (i.e., the student profile 21 and the MPN profile 22 described below).

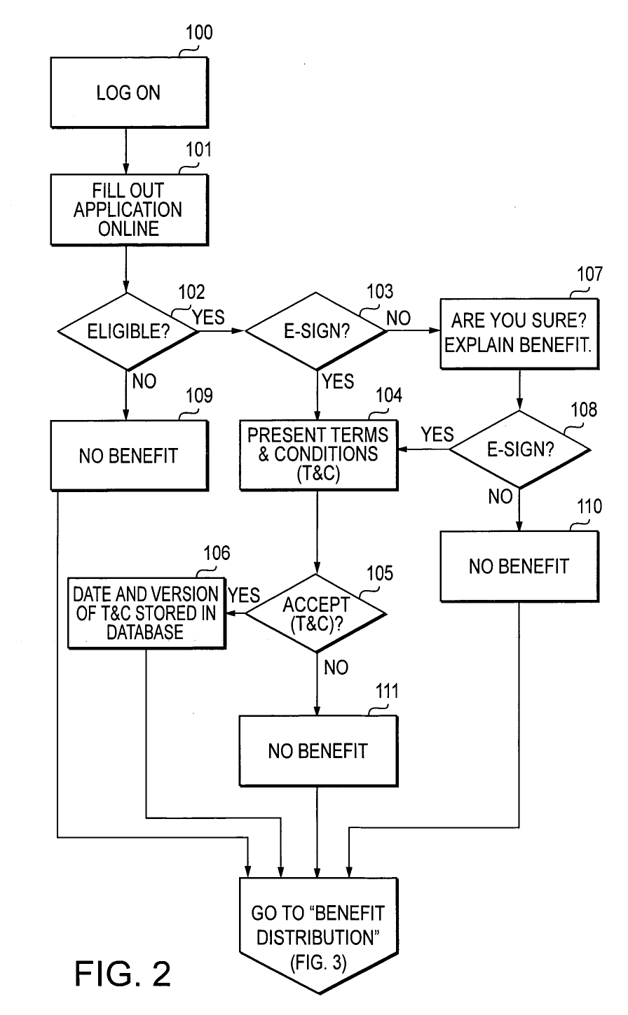

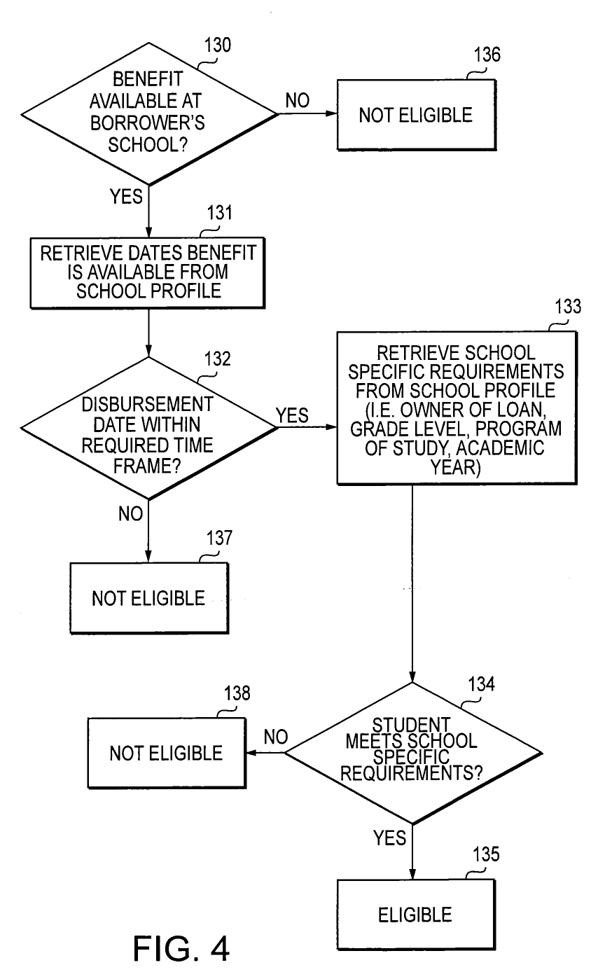

Referring now to FIGS. 1 and 2, the method containing the steps related to the online loan application process are described. When the student 17 logs-on at step 100 to the lender website 12 and begins the web-based loan application process at step 101, the system 10 determines whether the student 17 is eligible for the benefit 18 at step 102. The eligibility determination process (described below in reference to FIG. 4) is based on the school profile 20 stored within the system 10.

When the student 17 finishes the online application at step 101, he/she has the option 103 to electronically sign the MPN 25. If the system 10 finds that the student 17 is eligible for the benefit 18, he/she will be prompted to electronically sign the note. If he/she does not select the electronic signature option, he/she is prompted to reconsider the decision at step 107, and informed that the electronic signature is a requirement to receive the benefit 18. If the student 17 does not elect to electronically sign at this time at step 108, he/she is not eligible for the benefit 18 at step 110. If at any time during the application process, the system 10 finds the student 17 to be not eligible, the benefit 18 will not be offered to the student 17 at step 109.

If the system 10 finds that the student 17 is eligible for the benefit 18, and they electronically sign the MPN 25, the system 10 prompts the student 17 to acknowledge and agree to the terms and conditions of the loan at step 104. In the illustrated embodiment, the terms and conditions include information such as the amount of the benefit (from the school profile) and the conditions that the student 17 must satisfy in order to receive the benefit 18. These requirements can be such factors as maintaining a valid email address, agreeing to receive servicing notification by email, making twelve on-time payments, and not consolidating the loan away from the lender 19, among others. The present invention is designed to incorporate any requirements as factors. Step 105 requires the student 17 to make a selection either accepting or declining the terms and conditions of the benefit 18. If the student 17 accepts the terms and conditions, the date and version of the terms and conditions that are accepted are stored in the database storage device 11 as part of the MPN Profile 22 at step 106. If the student 17 does not accept, he/she is not eligible for the benefit 18 at step 111.

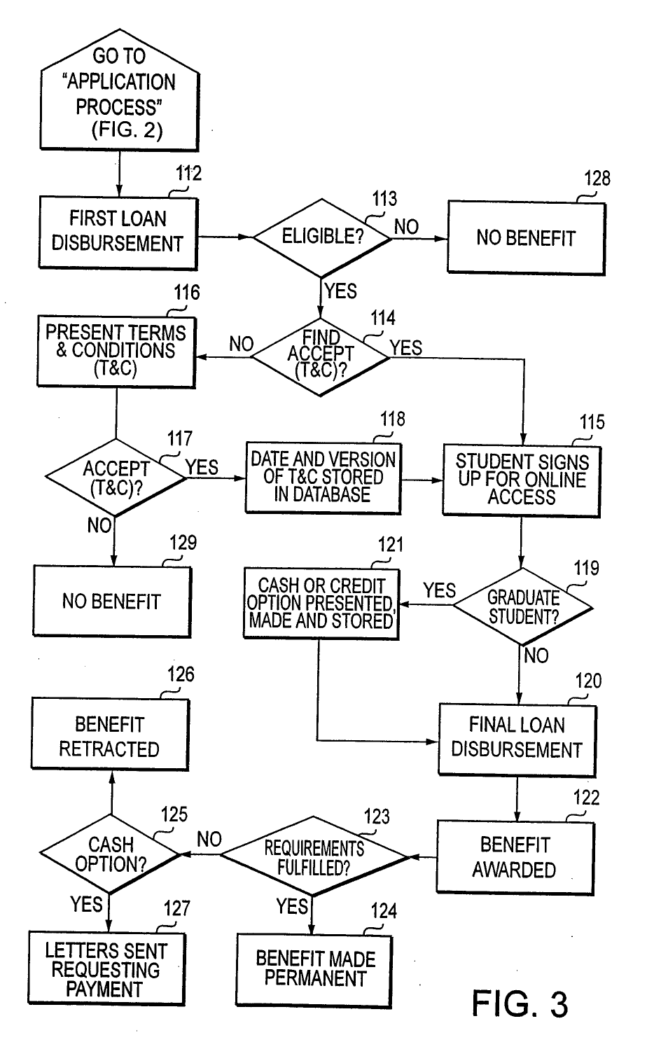

Referring now to FIG. 3, having found the student 17 eligible, the system 10 will proceed to distribute the benefit 18. At the time of first disbursement of the loan at step 112, the system 10 will repeat the eligibility process at step 113 (described below). If the student 17 is eligible, the system 10 will search in the database storage device 11 for a stored acceptance of the terms and conditions at step 114. If the student 17 is not eligible, the system 10 will not offer the benefit 18 at step 128. However, the system 10 may find that a student 17 has become eligible due to changes in the requirements set by the school 15 or a new LOU 16 (or other agreement).

Referring to FIG. 4, the system 10 follows a determination function to determine whether a student 17 is eligible for the benefit 18. The system 10 first conducts step 130 to determine if the benefit 18 is available at the school 15 attended by the student 17. If not, the student 17 is not eligible at step 136. If the benefit 18 is available, the system 10 continues to step 131 and retrieves the dates between which loans 14 are available for the benefit 18 and subsequently verifies if the disbursement date of the student's loan 14 is within the required range at step 132. If not, the student 17 is not eligible at step 137. If the disbursement date is within the range, the system 10 continues to step 133 and retrieves any school specific requirements from the school profile 20 such as the owner of the loan 14, grade level, program of study and academic year. Step 134 determines whether the student 17 meets any school specific requirements for the benefit. If the student 17 meets all of the requirements of steps 130-134, then he/she is eligible for the benefit 18 at step 135. If the student 17 does not meet the requirements, he/she will be found to be ineligible for the benefit 18 at step 138.

Referring back to FIG. 3, if at any time, e.g. during the determination process of FIG. 3, the system 10 does not find an acceptance of the terms and conditions, it either prompts the student 17 to accept them in the manner described above in connection with FIG. 2, or will send an email or letter 30 (FIG. 1) to the student 17 notifying him/her to visit the website 12 and accept the terms and conditions of the benefit 18. The student 17 will then be afforded a second opportunity to accept the terms and conditions at step 117. If he/she does not, the benefit 18 is not available at step 129. If he/she does accept, the date and version of the terms and conditions accepted are stored in the database storage device 11 as part of the MPN Profile 22 at step 118.

If the system 10 finds an acceptance of the terms and conditions, no further action is taken until the student 17 visits the website 12 and signs up for online account access at step 115 (FIG. 3), as provided for in the terms and conditions. At the time the student 17 signs up for online account access, if the student 17 is determined to be a graduate student at step 119, he/she is given the option to choose the form of the benefit 18. He/she can choose either an account credit 28 or cash 29. The default choice is an account credit 28. The student's choice will then be stored in the database storage device 11 as part of the benefit profile 23 at step 121.

Sixty days, or any other predetermined interval or other appropriate threshold, after the final disbursement of the benefit 120, if the loan 14 is owned by the lender 19, the agreed upon account credit 18 is automatically made to the student's loan account at step 122. On the other hand, if the loan 14 is not owned by the lender 19, the account credit will be awarded the day the loan 14 is purchased by the lender 19. If the student 17 indicated that he/she desired the cash incentive option 29, a check for the agreed upon or advertisement amount is processed and sent to him/her upon the satisfaction of the same lender ownership requirements under the account credit option at step 122.

If, for example, after the twelfth loan 14 payment is made by the student 17, or at a different predetermined time or threshold, the system 10 will verify whether the student 17 has fulfilled all the requirements to make the benefit 18 permanent at step 123. If the system 10 finds that the student 17 has fulfilled all of the requirements, the benefit 18 is made permanent at step 124 by automatically changing the status within the system 10 (stored in the benefit profile 23). No more action by the student 17 is required to effect the benefit. If the student 17 consolidates his/her loan 14 with the same lender 19 before twelve or any other threshold level of payments have been made or a different predetermined time has elapsed, the benefit 18 will automatically become permanent at that time and the student 17 no longer needs to satisfy that requirement.

If the system 10 finds that the student 17 has not fulfilled all of the requirements at step 125, the system 10 then investigates whether a check (cash 29) has previously been sent to the student 17 or an account credit 28 has been previously applied to his/her account 125. If the benefit 18 was in the form of an account credit 28, the credit is reversed at step 126 in the form of a principle-only transaction 31 posted to the student's loan 14 at the time set in the agreed upon terms and conditions. The student 17 is notified by email or letter 30 of the forfeited credit 28. The loan credit 28 benefit 18 is retracted and added to the payoff amount if the student 17 fails to comply with any other requirement set forth by the terms and conditions.

In the alternative, if a check (cash 29) was previously sent to the student 17, an email or letter 30 is sent to him/her at predetermined intervals 127 until the money has been paid back to the lender 19. If the loan 14 is not yet in repayment, the student 17 will not be billed for the retracted benefit 18 until the loan 14 is in repayment.

It should be appreciated that the educational loan embodiment described here is not the only use of this invention. The invention can be used to support with any other type of loan application process and incentive program within any type of industry that uses loan financing such as automobile, real estate, etc. or revolving credit applications, such as credit card repayment plans. The present invention is simply a lender-based management system designed to support the loan application process and various management tools, and to serve as an incentive program.

Having described specific preferred embodiments of the invention with reference to the accompanying drawings, it is understood that the invention is not limited to those precise embodiments, and that various changes and modifications may be effected therein by one skilled in the art without departing from the scope or the spirit of the invention as defined in the appended claims.

1. A financial computer system comprising:
a computer network;
at least one server in communication with the computer network;
a storage device for storing information;
at least one website linked to the at least one server through the computer network, wherein the website provides a user interface through which users can access an online loan application; complete the loan application and receive information regarding an incentive benefit; and
an incentive module for determining user eligibility for the incentive benefit based on terms and conditions stored in said storage device.

2. The financial computer system of claim 1, wherein the storage device stores a school profile, a student profile, a master promissory note profile and a benefit profile.

3. The financial computer system of claim 2, wherein the school profile comprises information about whether the benefit is available to the borrower's school and a benefit amount.

4. The financial computer system of claim 2, wherein the student profile comprises personal information and information about the school attended by the student, and the student's grade level and program of study.

5. The financial computer system of claim 2, wherein the master promissory note profile comprises a date the terms and conditions were accepted and a version of the terms and conditions that were accepted.

6. The financial computer system of claim 2, wherein the benefit profile comprises an option for cash or credit and a status as to whether the benefit is permanent.

7. A method of providing an incentive for borrowers during an online loan process, the method comprising the steps of:
storing on a storage device information about the terms and conditions a borrower must meet to receive a benefit;
accepting an electronic loan application from the borrower;
notifying the borrower of eligibility;
electronically providing the borrower with a set of terms and conditions to which the borrower can agree;
storing the status of the borrower's acceptance of the set of terms and conditions on the storage device;
if the borrower meets at least a portion of the set of terms and conditions, awarding the benefit to the borrower.

8. The method of claim 7, further comprising finalizing the benefit when the borrower complies with all of the set of terms and conditions.

9. The method of claim 7, further comprising retracting the benefit from the borrower when the borrower fails to comply with any one of the set of terms and conditions.

10. The method of claim 9, wherein the benefit is a monetary benefit, and the retracting step comprises:
determining whether the borrower received the benefit by account credit or check; and
if the borrower received the benefit by account credit, deducting the benefit from the borrower's account; or
if the borrower received the benefit by check, reacquiring the benefit by demanding repayment of the benefit from the borrower.

11. The method of claim 7, further comprising storing on a server an agreement between an institution and a lender, the agreement containing the set of terms and conditions.

12. The method of claim 11, wherein the step of storing on a server further comprises storing a plurality of agreements between the lender and the institution.

13. The method of claim 7, wherein the storing step further comprises storing a date associated with the borrower's acceptance of the set of terms and conditions.

14. A computer program transmitted over a communication medium to a computer system, the computer system comprising memory, a storage device and a processor in communication with the memory and the storage device, the computer program causing the processor to perform the acts of:
giving a borrower access to a loan application on a lender's website;
allowing the borrower to electronically sign the loan application;
determining whether the borrower is eligible for a benefit;
if the borrower is determined to be eligible for the benefit, electronically providing the borrower with a set of terms and conditions for receiving the benefit;
allowing the borrower to electronically accept the set of terms and conditions;
storing the borrower's acceptance of the set of terms and conditions on the server;
awarding the benefit to the borrower if the borrower agrees to the set of terms and conditions.

15. The computer program of claim 14, wherein the computer program further causes the processor to perform the acts of:
if the borrower completes the set of terms and conditions, finalizing the benefit; or
if a portion of the set of terms and conditions are not fulfilled by the borrower, retracting the plurality of benefits from the borrower.

16. The computer program of claim 15, wherein the act of retracting comprises:
determining whether the borrower received the benefit by account credit or check; and
reacquiring the benefit if the borrower received the benefit by credit or if the borrower received the benefit by check, reacquiring the benefit by demanding payment from the borrower placing a deduction on the borrower's loan account.

17. The computer program of claim 14, wherein the act of storing further comprises storing a date associated with the borrower's acceptance of the set of terms and conditions.

18. The computer program of claim 14, wherein the act of determining whether the borrower is eligible comprises:
retrieving a set of school specific requirements from a school profile; and
determining whether the borrower satisfies all requirements of the set of school specific requirements.

19. The computer program of claim 18, wherein the act of determining whether the borrower satisfies all requirements further comprises retrieving information about the owner of the loan, the grade level of the borrower, the program of study of the borrower and the academic year of the borrower.

20. A method of providing an incentive program for borrowers, the method comprising the steps of:
providing a borrower an online loan application;
storing on a storage device the requirements for receiving a benefit;
determining whether a borrower is eligible for the benefit;
electronically providing the borrower with a set of terms and conditions if the borrower is determined to be eligible;
allowing the borrower to electronically agree or disagree with the set of terms and conditions;
storing the borrower's acceptance of the set of terms and conditions on the server; and
awarding the benefit to the borrower if the borrower agrees to the set of terms and conditions.

21. The method of claim 20, further comprising the act of finalizing the benefit award when the borrower has completed all of the requirements of the loan of all requirements.

22. The method of claim 20, further comprising the act of retracting the benefit from the borrower if any one of the requirements are not fulfilled.

23. The method of claim 22, wherein the retracting step comprises:
determining whether the borrower received the benefit by account credit or check; and
if the borrower received the benefits by account credit, reacquiring the benefit by deducting the benefit from the borrower's account; or
if the borrower received the benefit by check, reacquiring the benefit by demanding payment from the borrower.

24. The method of claim 20, wherein the determining step comprises:
retrieving a set of school specific requirements from the school profile; and
determining whether the borrower satisfies all requirements of the set of school specific requirements.

25. The method of claim 20, wherein the storing step further comprises storing a date associated with the borrower's acceptance of the set of terms and conditions.
